(19) United States
(12) Patent Application Publication
(10) Pub. No.: US 2015/0292908 A1
(43) Pub. Date: Oct. 15, 2015

(54) INTEGRATED HARDWARE AND SOFTWARE FOR PROBE

(71) Applicant: INTEL CORPORATION, Santa Clara, CA (US)

(72) Inventors: Minglei Wang, Shanghai (CN); Kapil Kane, Shanghai (CN); Russell Beauregard, Portland, OR (US)

(21) Appl. No.: 13/976,824

(22) PCT Filed: Jan. 24, 2013
(86) PCT No.: PCT/CN2013/070948

§ 371 Date: Jun. 27, 2013

(51) Int. Cl. G01D 5/16; G01H 17/00; G01K 17/00

(52) U.S. Cl. CPC G01D 5/16; G01K 17/00; G01H 17/00

(57) ABSTRACT

A computing device is described. The computing device may include a port to receive voltage from a probe. The computing device may include logic at least partially comprising hardware to determine a resistance level associated with the voltage. The logic may route the voltage based on the resistance level. The logic may associate the resistance level with a specific context.

### TECHNICAL FIELD

This disclosure relates generally to methods and systems of integrating software and hardware related to contextual data gathering. More specifically, the techniques disclosed relate to a computing device having a port to receive voltage from a probe and analyze the voltage to determine a specific context.

### BACKGROUND ART

Computing devices may be used as educational devices. In some cases, computing devices have been used as educational platforms for schools to provide enriched user experiences for students. In some cases, peripheral devices having sensors may be connected to a computing device to create a hands-on learning environment. For example, a peripheral device may include sensors such as thermometers, barometers, light sensors, and the like. The peripheral device may include hardware and software to measure contextual data. The hardware and software may be used to perform operations for detecting the contextual data and provide the contextual data to the computing device.

### BRIEF DESCRIPTION OF THE DRAWINGS

FIG. 1 is a block diagram illustrating a system including a computing device communicatively coupled to a probe.

FIG. 2 is a block diagram illustrating a probe interface of the computing device.

FIG. 3 is a drawing illustrating an embodiment of a computing device coupled to a probe.

FIG. 4 is a block diagram illustrating a method 400 of receiving voltage from a probe.

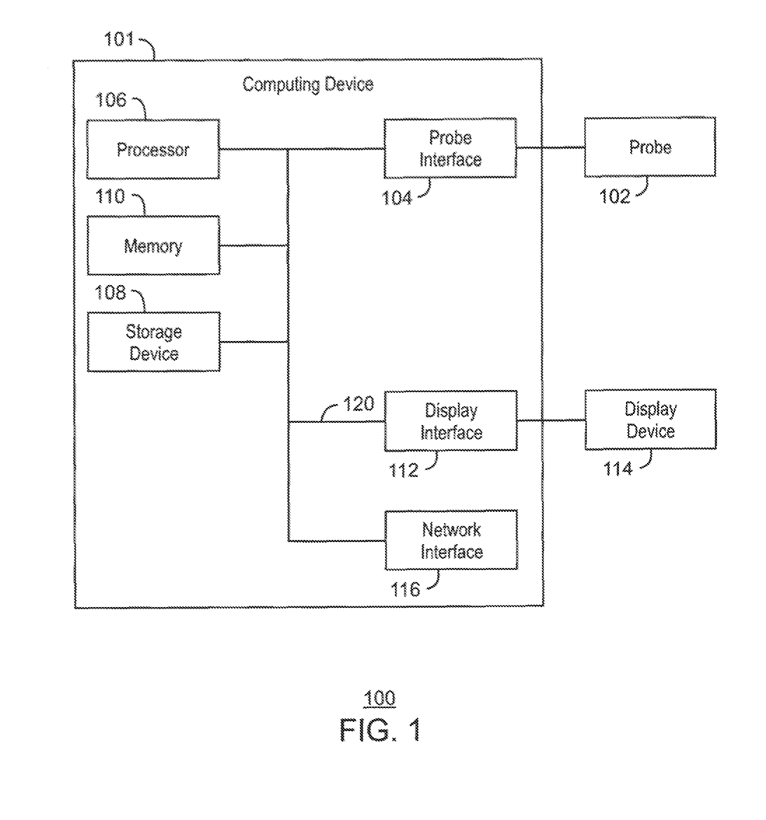

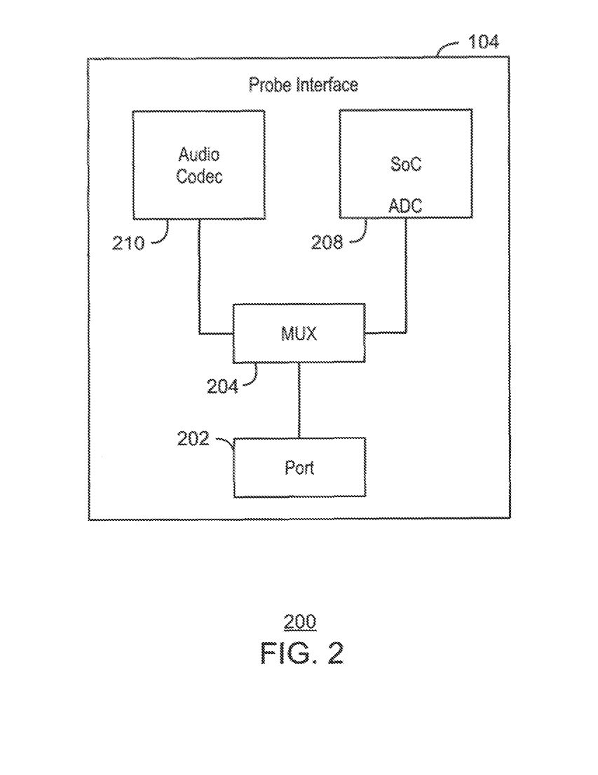

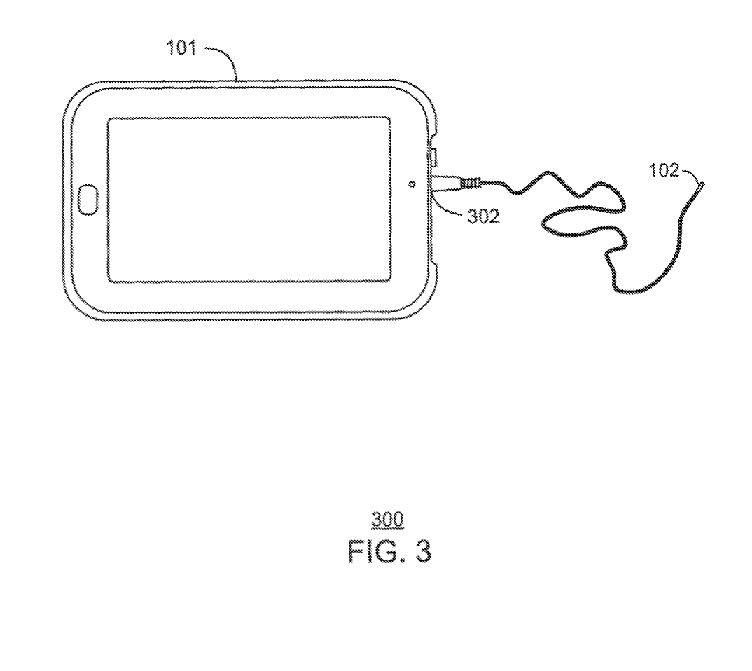

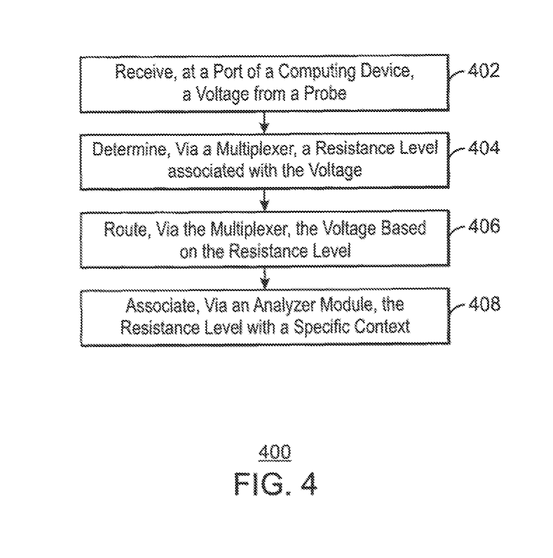

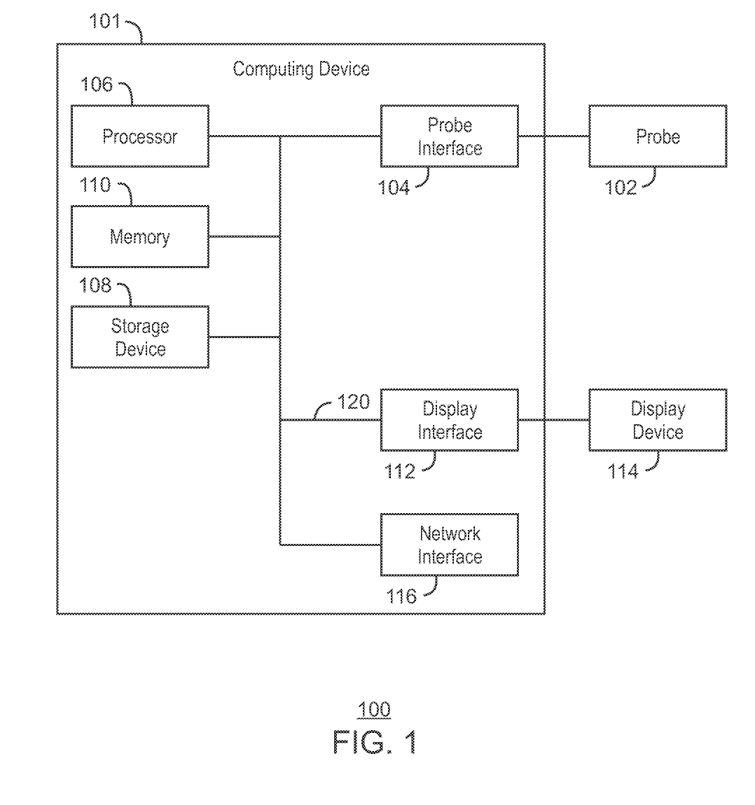

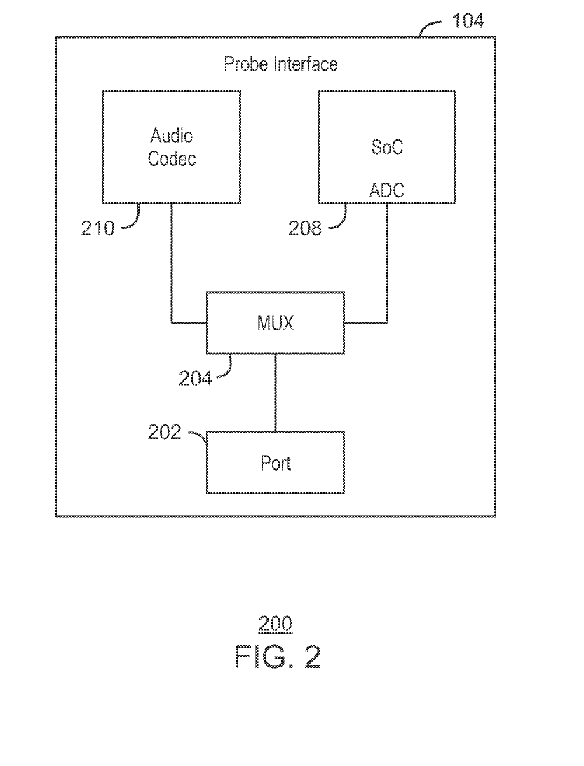

The same numbers are used throughout the disclosure and the figures to reference like components and features. Numbers in the 101 series refer to features originally found in FIG. 1; numbers in the 200 series refer to features originally found in FIG. 2; and so on.

### DESCRIPTION OF THE EMBODIMENTS

The present disclosure relates generally to a computing device having an internal probe interface. More specifically, the present disclosure includes logic to receive voltage from a probe, such as a thermistor, and associate the voltage with a specific context. The computing device may be used to take measurements of contextual data, such as temperature, atmospheric pressure, ambient light, and the like. Rather than including the logic on a peripheral device, the present disclosure integrates the logic within the computing device. By integrating the logic for the probe, the computing device may be used to gather contextual data in a less expensive manner than if a peripheral device having logic to measure the contextual data was used.

FIG. 1 is a block diagram illustrating a system 100 including a computing device 101 communicatively coupled to a probe 102. The computing device 101 includes a sensor interface 104. The sensor interface 104 may be configured to receive voltage from the probe 102. The voltage may be associated with a specific context. The computing device 101 also includes a processor 106 and a storage device 108.

The computing device 101 may be, for example, a laptop computer, desktop computer, tablet computer, mobile device, server, or cellular phone, a wearable computing device, among others. The processor 106 can be a single core processor, a multi-core processor, a computing cluster, or any number of other configurations. The processor 106 may be implemented as Complex Instruction Set Computer (CISC) or Reduced Instruction Set Computer (RISC) processors, x86 Instruction set compatible processors, multi-core, or any other microprocessor or central processing unit (CPU). In some embodiments, the main processor 106 includes dual-core processor(s), dual-core mobile processor(s), or the like.

The computing device 101 may include a memory device 110. The memory device 110 can include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems.

The processor 106 may be connected through a system bus 120 (e.g., PCI, ISA, PCI-Express, HyperTransport®, NuBus, etc.) to the sensor interface 104. The processor 106 may also be linked through the system bus 120 to a display interface 112 adapted to connect the computing device 101 to a display device 114. The display device 114 may include a display screen that is a built-in component of the computing device 101. The display device 114 may also include a computer monitor, television, or projector, among others, that is externally connected to the computing device 101.

The storage device 108 may be a non-transitory computer-readable medium. The storage device 108 may have instructions stored thereon that when executed by the processor 106 cause the computing device 101 to perform operations. In some embodiments, the operations may be executed by a controller (not shown). In these embodiments, the controller may be a microcontroller configured to carry out the operations related to receiving voltage related to contextual data. In other embodiments, the operations may be executed by logic at least partially comprising hardware logic. Hardware logic at least partially includes hardware, and may also include software, or firmware. Hardware logic may include electronic hardware including interconnected electronic components to perform analog or logic operations on the computing device 101. Electronic hardware may include individual chips/circuits and distributed information processing systems. The operations may include determining a resistance level associated with the voltage received at the port (not shown) of the probe interface 104. The operations may include routing the voltage based on the resistance level. The operations may include associate the resistance level with a specific context.

For example, the probe 102 may be a temperature probe configured to detect voltage associated with a temperature including a range of temperatures. In some embodiments, the probe 102 may be a resistance thermometer, also referred to herein as a resistance temperature detector (RTD). An RTD may be configured to measure the resistance of the RTD element associated with a temperature. In some embodiments, the RTD consists of a length of fine coiled wire wrapped around a ceramic or glass core. The RTD element may be disposed of a metal including platinum, nickel, or copper. The material of the probe 102 may be configured to change in terms of voltage resistance as the temperature changes. In some embodiments, the probe 102 may be a negative temperature coefficient (NTC) thermistor. In this embodiment, the resistance provided from the probe 102 to the probe interface 104 decreases with increasing temperature. In other embodiments, the probe 102 is any other type of probe configured to measure a specific context such as atmospheric pressure, light levels, volatile organic compound levels, and the like.

FIG. 2 is a block diagram illustrating the probe interface 104 of the computing device 101. The probe interface 104 may be configured to receive voltage from a probe, such as the probe 102 of FIG. 1. The probe interface 104 may include a port 202 to receive the voltage and a multiplexer 204 to route the voltage. The probe interface 104 may include an analyzer 208 module to analyze the resistance level and determine the contextual data based on the resistance level.

The multiplexer 204 may include a resistor configured to detect a resistance level of the voltage to route the voltage to the analyzer 208. In some embodiments, the port 202 includes pins to receive the voltage. The multiplexer 204 may be configured to detect the port 202 is coupled to a probe, such as the probe 102 of FIG. 1. In some embodiments, the port 202 may be an audio port coupled to an audio device such as a headphone, a microphone, and the like. In this embodiment, the multiplexer 204 is configured to detect that the port 202 is coupled to an audio device (not shown) based on the resistance level of the voltage. In this embodiment, the resistance level on each of the pins may vary based on the probe. For example, when the computing device 101 is coupled to stereo headphones, a first pin is coupled to a left line of the stereo headphone, the first pin may have a voltage of 32 ohm. Likewise, when the computing device is coupled to stereo headphones, a second pin is coupled to a right line of the stereo headphone, the second pin may have a voltage of 32 ohm. However, as illustrated in Table 1 below, when the computing device 101 is coupled to a probe, such as a thermistor, the first pin may be open or associated with an infinite voltage, and the second pin may have a voltage of 500 ohm. By detecting the voltage or the resistance level associated with the voltage, the port 202 may be as simple as an audio port, such as a headphone jack, and may be used to receive voltage associated with contextual data. However, the port 202 is not limited to a headphone jack. In some embodiments, the port 202 may be any port adapted to provide voltage from a probe such as universal serial bus, a peripheral component interconnect express, serial ATA, a two wire interface, and the like.

TABLE 1

| Device Inserted | Audio Jack Pin 1 | Pin 2 | Pin 3 | Pin 4 |
|---|---|---|---|---|
| Mono earphone | Earphone, 32 ohm | Ground, 0 ohm | Ground, 0 ohm | Ground, 0 ohm |
| Stereo earphone | left earphone, | right earphone, | Ground, 0 ohm | Ground, 0 ohm |
| | 32 ohm | 32 ohm | | |
| Stereo earphone | left earphone, | right earphone, | Ground, 0 ohm | MIC |
| with MIC | 32 ohm | 32 ohm | | |
| Thermal probe | Open, ∞ ohm | NTC thermistor | NTC thermistor, | Open, ∞ ohm |
| | | >500 ohm | ground | |

The analyzer 208 may be a system on a chip (SoC) and may include an analog to digital converter to convert the voltage to a digital signal. The digital signal may then be analyzed to determine the contextual data based on the resistance level of the voltage received at the port 202.

The probe interface 104 is integrated within the computing device 101. By integrating the probe interface 104, measuring contextual data such as temperature may be less complicated, and produce less errors, than if the probe interface 104 was a part of a peripheral device requiring software to be installed on the computing device 101.

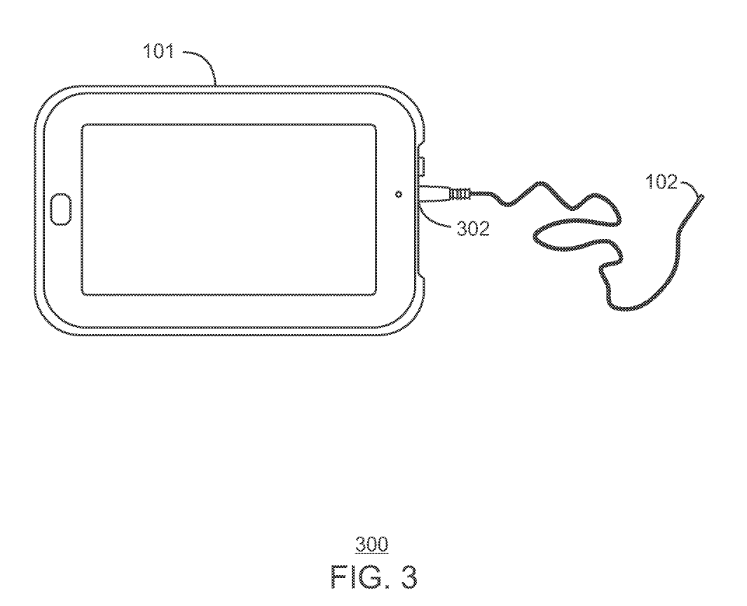

FIG. 3 is a drawing illustrating an embodiment of the computing device 101 coupled to a probe 102. In this embodiment, the computing device 101 is tablet and the probe 102 is a temperature resistor, or a thermistor. The probe 102 is coupled to the computing device 101 via a headphone port 302. A user may connect the probe 102 to the computing device 101 without requiring any additional software or hardware components. The computing device 101, via the probe interface 104, may determine the contextual data, or specific context, associated with a voltage gathered by the probe 102 and received at the port 302.

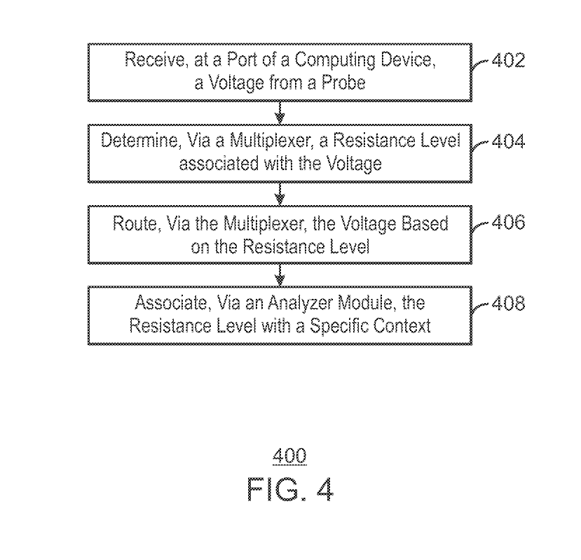

FIG. 4 is a block diagram illustrating a method 400 of receiving voltage from a probe. The method 400 may include receiving, at block 402, a voltage from a probe. The voltage may be received at a port of a computing device. The method 400 may include determining, at block 404, a resistance level associated with the voltage. The resistance level may be determined via a multiplexer of the computing device. The method 400 may include routing, at block 406, the voltage based on the resistance level. The voltage may be routed via the multiplexer of the computing device to an analyzer module. The method 400 may include associating, at block 408, via the analyzer module, the resistance level with a specific context.

For example, the method 400 may be carried out in the context of temperature measurements. A probe may gather voltage readings correlated with a certain temperature or range of temperatures. A resistance level associated with the voltage may indicate that the probe is providing data associated with the temperature or range of temperatures. In some embodiments, the port may be an audio port otherwise used to couple the computing device to headphones, a microphone, and the like. In this embodiment, the port may include pins and the method 400 may include receiving voltage from the probe at each of the pins. The voltage at each of the pins may indicate which type of peripheral component, such as a probe or headphones, are coupled to the computing device. By determining the voltage to be associated with a temperature probe, the method may route the voltage to an analyzer module. The method may then associate the voltage and the resistance level associated with the voltage with the temperature or range of temperatures.

In some embodiments, the method 400 may include converting the voltage received from an analog format to a digital format. In this embodiment, the digital format may be analyzed to determine the specific context associated with the voltage, and the resistance level associated with the voltage.

In some embodiments, the multiplexer, the port, and the analyzer are each integrated as a combination of hardware and logic within the computing device. For example, the port may be an audio port, the multiplexer may be electronic circuitry, and the analyzer module may be an integrated circuit or system on a chip. By integrating these components, the method 400 may be carried out relatively less expensively and with relatively less hardware and software compatibility issues that if these components were provided as peripheral components to the computing device.

Some embodiments may be implemented in one or a combination of hardware, firmware, and software. Some embodiments may also be implemented as instructions stored on the tangible non-transitory machine-readable medium, which may be read and executed by a computing platform to perform the operations described. In addition, a machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A system, comprising;
a probe to provide a voltage to the system, wherein the voltage is related to contextual data;
an interface of a computing device comprising:
a port to receive the voltage;
a multiplexer to route the voltage;
a resistor to measure a resistance level of the voltage; and
an analyzer module to determine the contextual data based on the resistance level.

2. The system of claim 1, comprising an analog to digital converter to convert voltage received in an analog format to digital format to be analyzed by the analyzer module.

3. The system of claim 1, comprising pins to receive the voltage wherein the resistance level on each of the pins may vary based on the probe.

4. The system of claim 1, wherein the port is an audio port and wherein the multiplexer is to detect that the port is coupled to an audio device based on the resistance level.

5. The system of claim 1, wherein the multiplexer is to detect a resistance level of the voltage to route the voltage to the analyzer.

6. The system of claim 1, wherein the probe is a thermistor probe, and wherein the contextual data is a temperature associated with the resistance level.

7. The system of claim 1, wherein the interface is integrated within the computing device.

8. A computing device, comprising:
a port to receive voltage from a probe;
logic at least partially comprising hardware to:
determine a resistance level associated with the voltage;
route the voltage based on the resistance level; and
associate the resistance level with a specific context.

9. The computing device of claim 7, comprising an analog to digital converter to convert the voltage to digital format to be associated with the specific context.

10. The computing device of claim 7, comprising pins wherein the resistance level on each of the pins may vary based on the probe.

11. The computing device of claim 7, wherein the port is an audio port and wherein the logic is to detect that the port is coupled to an audio device based on the resistance level.

12. The computing device of claim 7, wherein the logic comprises:
a multiplexer to route the voltage based on the resistance level;
a resistor to measure the voltage; and
an analyzer module to associate the resistance level with a specific context.

13. The computing device of claim 7, wherein the probe is a thermal probe, and wherein the specific context is a temperature associated with the resistance level.

14. The computing device of claim 7, wherein the logic is integrated within the computing device.

15. A method, comprising:
receiving, at a port of a computing device, a voltage from a probe;
determining, via a multiplexer, a resistance level associated with the voltage;
routing, via the multiplexer, the voltage based on the resistance level; and
associating, via an analyzer module, the resistance level with a specific context.

16. The method of claim 15, comprising converting the voltage to digital format to be associated with the specific context.

17. The method of claim 15, wherein the port comprises pins, comprising receiving the voltage from the probe at each of the pins.

18. The method of claim 17, wherein the voltage received may vary based on the probe.

19. The method of claim 7, wherein the port is an audio port, comprising detecting whether the port is coupled to an audio device based on the resistance level.

20. The method of claim 7, wherein the probe is a thermal probe, and wherein the specific context is a temperature associated with the resistance level.

21. The method of claim 7, wherein the multiplexer, the port, and the analyzer are each integrated as a combination of hardware and logic within the computing device.
